(19) United States
(12) Patent Application Publication
(10) Pub. No.: US 2012/0220175 A1
(43) Pub. Date: Aug. 30, 2012

(54) WATER VEHICLE ENABLING MOVEMENT ON OR UNDER WATER

(75) Inventor: François-Alexandre Bertrand, Ramatuelle (FR)

(73) Assignee: IDEOTHEQUE, Ramatuelle (FR)

(21) Appl. No.: 13/501,876

(22) PCT Filed: Oct. 14, 2010
(86) PCT No.: PCT/FR2010/000684

§ 371 Date: May 22, 2012

(30) Foreign Application Priority Data
Oct. 14, 2009 (FR) 0904942

(51) Int. Cl. B63B 1/02; B63B 17/00; B65H 79/00; B63B 1/12; B63H 16/00; F04B 35/01; B63H 25/38; B63H 20/08; B63B 39/00; B63B 39/03; B63C 11/16; A62B 7/04; B63H 21/17; B63H 11/00; B63B 19/00; B63H 25/02; B63B 1/10

(52) U.S. Cl. 440/6; 114/56.1; 114/61.1; 114/61.22; 440/25; 114/162; 440/38

(57) ABSTRACT

A water vehicle moving on or in a liquid and including a flotation element (1) that is connected by a connection member (6) to a carrier (3), the water vehicle being characterized in that the connection member (6) is shaped so as to enable the carrier (3) to assume at least two positions, namely:—a raised position where the longitudinal axis of the carrier (3) and those of the flotation element (1) substantially extend into the same horizontal plane, the carrier (3) then being on the surface and capable of making up a central shell; and—a lowered position where the carrier (3) extends under the plane including the longitudinal axis of each of the flotation element (1), the carrier (3) then being submerged.

The present invention relates to a water vehicle enabling movement on or under water. It in particular, but not exclusively, relates to a water vehicle preferably propelled by human force, allowing users to be positioned below or above the surface.

It is known that small underwater vehicles exist, propelled by a motor and/or action on a pedal and gear mechanism, comprising a closed receptacle and capable of moving independently at shallow depths. Nevertheless, this type of vehicle is specifically designed for movement under the water at an average depth generally between 15 and 30 m, which requires:
transporting them to the submersion site using a boat; and
designing a complex and costly infrastructure in particular making it possible during submersion to supply passengers with breathable air and guarantee the sealing of the walls of said receptacle in which the passengers are located.

The present invention therefore first aims to eliminate these drawbacks.

To that end, it proposes a water vehicle moving on or in a liquid, which comprises float means connected by connecting means to a support, characterized in that said connecting means are configured so as to allow said support to assume at least two positions, i.e.:
a raised position where the longitudinal axis of said support extends above the surface level of said liquid, or in the plane defined by that surface;
a lowered position where the longitudinal axis of said support extends below said surface level, the support then being submerged.

Preferably, said support can assume at least two positions, i.e.:
a raised position where the longitudinal axis of said support and those of the float means extend substantially in the same horizontal plane, the support then being on the surface and able to constitute a central hull;
a lowered position where said support extends under the plane comprising the longitudinal axis of each of the float means, the support then being submerged.

Preferably, the float means are made up of two substantially parallel floats having sufficient spacing to allow the support to extend in the space thus formed, the longitudinal axis of the support being substantially parallel to that of the floats.

Preferably, the support comprises at least one location allowing at least one passenger to settle therein.

The water vehicle according to the invention includes:
control means allowing the passengers to control the raising or lowering of said support, which gives them the possibility of choosing to move on the water or under the water;
propulsion means preferably made up of a pedal and gear—transmission means—propeller assembly and/or a motor—transmission means—propeller assembly.

Furthermore, the water vehicle according to the invention can also comprise breathing means, which may comprise at least one pressure reducer or a snorkel tip with or without a valve, connected by at least one flexible hose to at least one opening formed in the portion of the structure of said water vehicle that remains on the surface, said opening emerging in the open air.

According to one alternative embodiment of the invention, said snorkel can be connected to a compressor—pressure reducer system associated with a valve that makes it possible, when open, to reduce the pressure of the air supplied by said system when the latter is greater than the pressure of the ambient air.

In this way, in the lowered position, each user present in the completely submerged support can breathe by using a pressure reducer or an elongated snorkel, positioned in the mouth beforehand.

Advantageously, users of the device according to the invention can thus go to the “dive” site while remaining on the surface and order the submersion of said support after arriving at the vertical of the area to be explored, the device according to the invention thus having multiple uses.

According to one alternative embodiment of the invention, said connecting means can be configured so as to allow said support to assume at least one intermediate position so as, for example, to be partially submerged, the passengers thus being able to have their legs underwater and the upper part of the body above the surface.

Furthermore, the water vehicle according to the invention comprises steering means that may consist of the least one handlebar connected to a rudder.

According to one alternative embodiment of the invention, the support of the water vehicle can include a closed receptacle comprising at least one porthole.

One embodiment of the invention will be described below, as a non-limiting example, in reference to the appended drawings, in which:

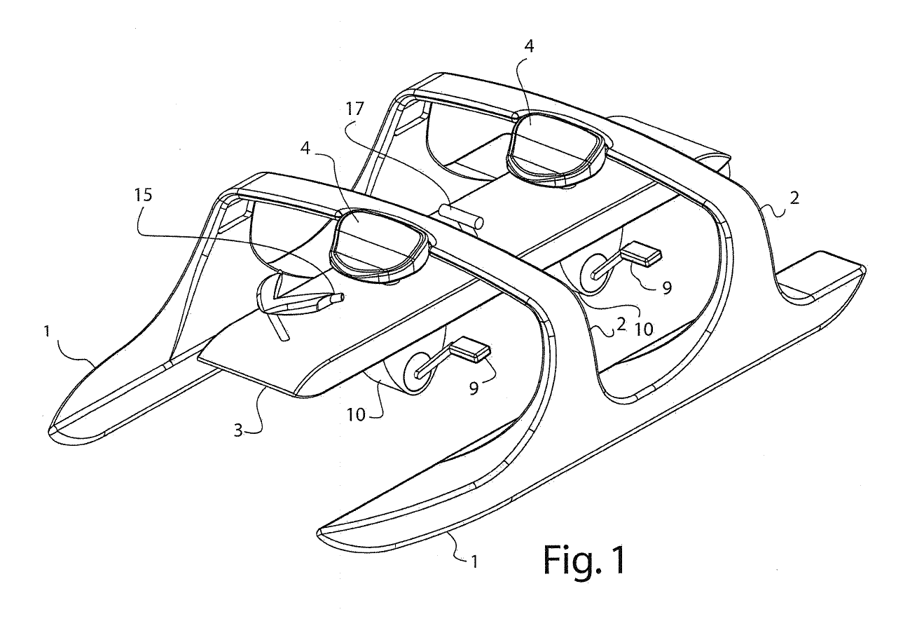

FIG. 1 is a diagrammatic perspective illustration of the water vehicle according to the invention.

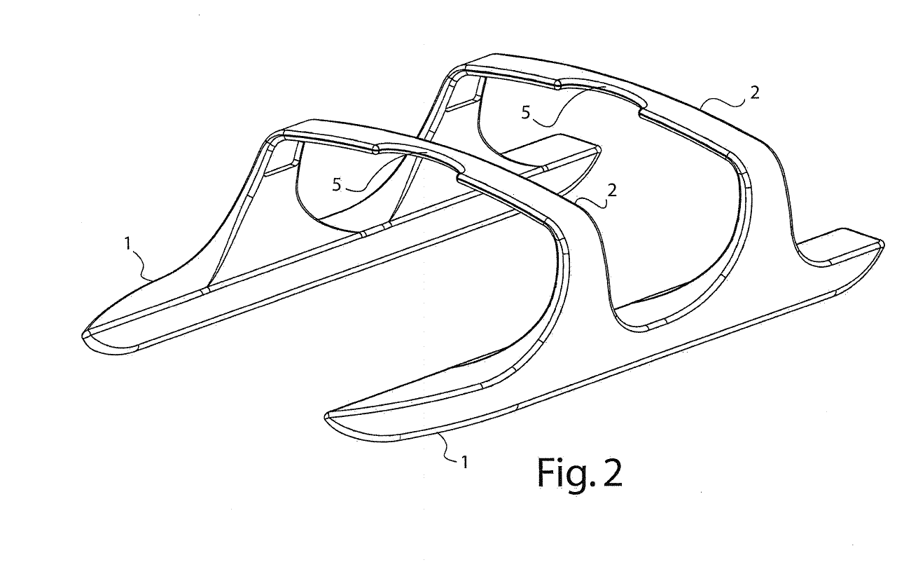

FIG. 2 is a diagrammatic perspective illustration of the floats of the water vehicle shown in FIG. 1, showing the cross ties making it possible to couple them.

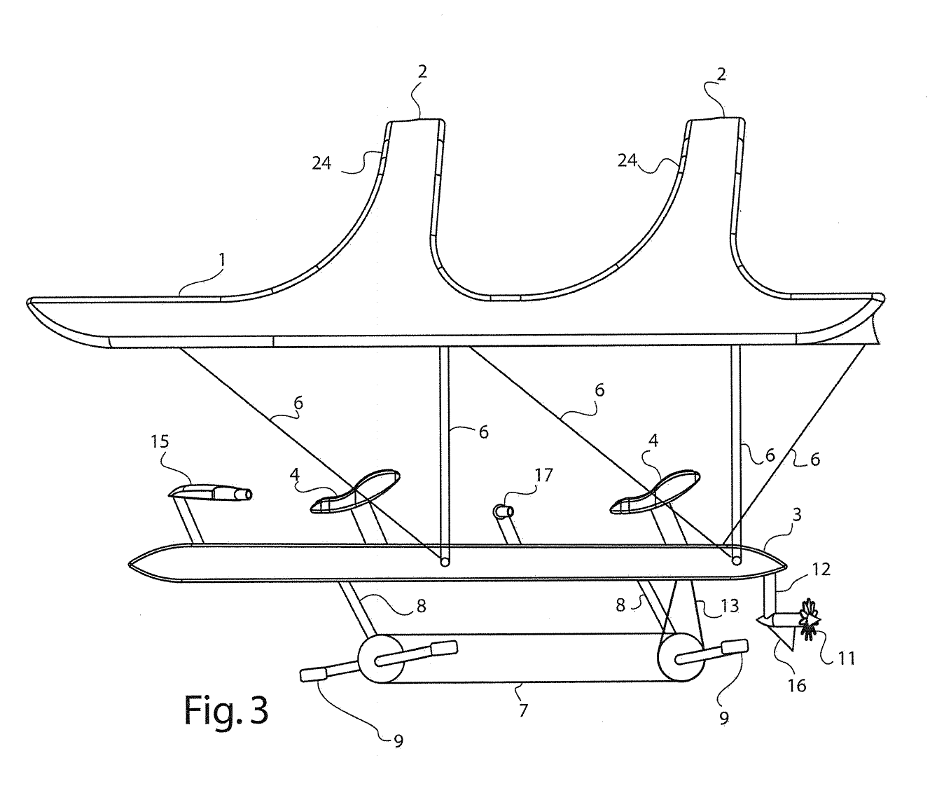

FIG. 3 is a diagrammatic side view of the water vehicle according to the invention, the support where the users may be present being in the lowered position.

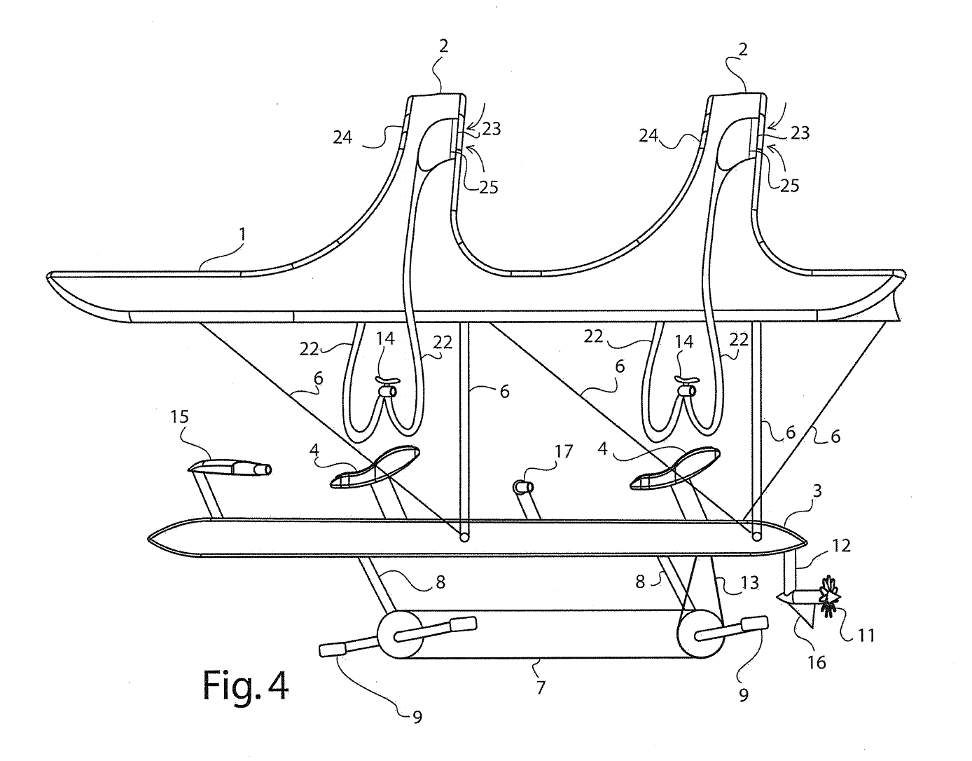

FIG. 4 is a diagrammatic side view of the water vehicle shown in FIG. 3, showing the breathing means.

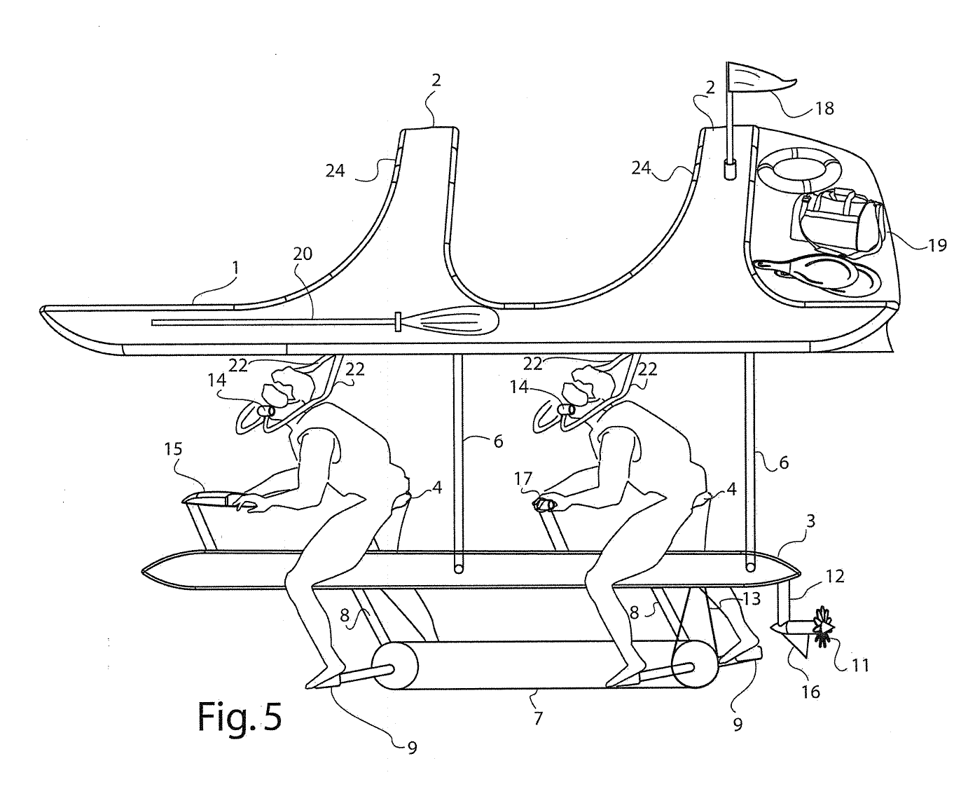

FIG. 5 is a diagrammatic side view of the water vehicle shown in FIG. 4, with users present on the support thereof.

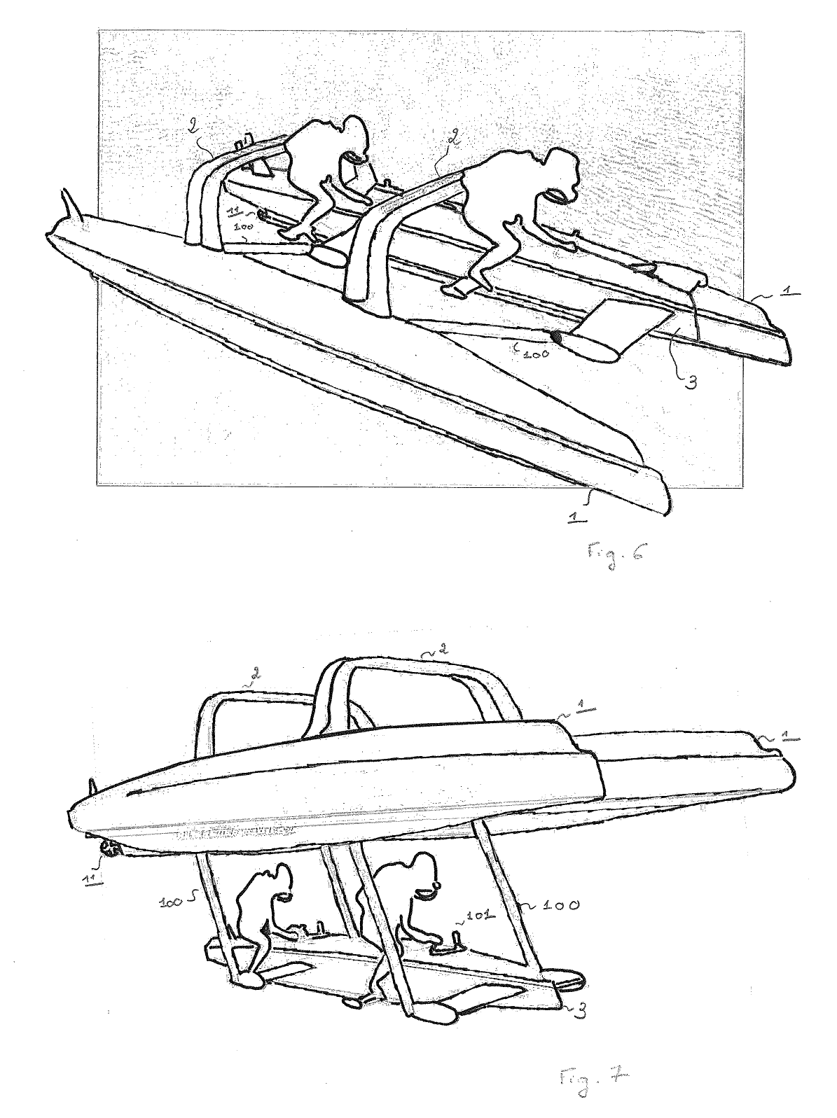

FIG. 6 is a diagrammatic top view of the water vehicle according to one alternative embodiment of the invention, the support of said water vehicle constituting a cradle without pedals.

FIG. 7 is a diagrammatic side view of the water vehicle shown in FIG. 6, the cradle being submerged.

In this example, as shown in particular in FIGS. 1 and 2, the water vehicle according to the invention comprises float means 1 that can consist of two substantially parallel floats 1, with longitudinal axes, which each form a lateral hull.

These two floats 1 are connected to one another by connecting means 2 that may consist of at least one cross tie 2 connected at each of its ends to the upper portion of the corresponding float 1, each cross tie 2 being able to be substantially hoop-shaped.

In the case at hand, the water vehicle according to the invention includes two substantially parallel cross ties 2 of the aforementioned type. In this way, the assembly formed by the floats 1 and the cross ties 2 is substantially in the shape of the lower structure of a catamaran.

The floats 1 can be rigid, semi-rigid or inflatable.

The volume of air comprised in the floats 1, when they are inflatable, can be adapted as a function of the submerged or emerged state of the support 3. In this way, as an example, when the support 3 is submerged, the floats 1 can be partially filled with air, the complete inflation of the floats 1 being able to be performed by an air pump (not shown) actuated using a pedal and gear mechanism 9 and/or a motor after emersion of the support 3, which facilitates forward motion of the water vehicle during surface movements.

As shown in FIG. 1, the water vehicle according to the invention can comprise a support 3 with a longitudinal axis, which extends between the two said floats 1, the longitudinal axis of the support 3 being substantially parallel to that of the floats 1.

This support 3, which is intended to be submerged and emerged, is preferably configured aerodynamically and in such a way as to offer little water resistance.

In the case at hand, the support 3 comprises, on the upper surface thereof, two locations 4 making it possible to place two passengers, each of said locations comprising a seat 4. As shown in FIGS. 3 and 4, these two locations 4 each comprise a stool 4, the height of which is preferably adjustable.

As shown in FIG. 2, the front part of each cross tie 2 comprises a central indentation 5 whereof the longitudinal axis fits substantially into the longitudinal plane of symmetry of the water vehicle. Advantageously, this indentation 5 matches the shape of the back portion of the corresponding seat 4, so as to allow better fastening of the support 3 to the float means 1 when said support 3 is in the raised position.

As shown in FIGS. 3 to 5, the floats 1 are connected to said support 3 by connecting means 6 allowing said support 3 to assume at least two positions, i.e.:
a raised position where the longitudinal axes of said support 3 and the float means 1 extend substantially in the same horizontal plane, the support 3 then being on the surface;
a lowered position where said support 3 extends under the plane comprising the longitudinal axis of each float means 1, the support 3 then being submerged.

As an example, said connecting means 6 can include rigid elements such as rods and/or tubes and/or bars, and/or flexible elements such as belts and/or ropes and/or chains and/or cables whereof the respective ends are connected to the float means 1 and the support 3, said connecting means 6 then being able to cooperate with gear mechanisms (not shown) when they are rigid, or to wind around pulleys (not shown) when they are flexible. Thus, by controlling the translation of said rods 6 and/or the winding or unwinding of said belts 6, the support 3 can be provided in the raised position or lowered position.

The water vehicle according to the invention can comprise control means allowing passengers to control the raising or lowering of said support 3, said control means, which comprise force reduction gear mechanisms, in particular being able to consist of:
a hoist (not shown) or a winch (not shown), whether manual or electric;
a pedal and gear mechanism 9—gearbox (not shown) assembly; in this way, the pedal and gear mechanism 9, the main function of which is to allow the propulsion of the water vehicle, can also be used for winding or unwinding the connecting means 6, the gearbox more specifically making it possible to control, owing for example to the gear mechanism, said winding or unwinding.

Advantageously, said control means make it possible to control the submersion depth of the support 3, the latter generally being able to be between a meter and a meter and a half.

Advantageously, the force reduction gear mechanisms included in the control means make it possible to facilitate the raising and lowering of said support 3. In this way, for example using the gearbox, the user can select a relatively low gear reduction when the support 3 is underwater, and a relatively high gear reduction when the support 3 is above water, which makes it possible to limit the necessary forces.

The water vehicle according to the invention also comprises fastening means (not shown) that make it possible to fasten the support 3 to the float means 1 and/or to the cross ties 2 when said support 3 is in the raised position, said fastening means thus making it possible to keep the support 3 in position relative to the float means 1. These fastening means can for example consist of hooks or straps.

According to one alternative embodiment of the invention, the support 3 can be separated from the float means 1 so as to allow independent underwater movement of the latter part 3. In that case, the water vehicle according to the invention comprises disconnectable fastening means (not shown) that may for example consist of a spring hook—fastening ring assembly respectively connected to the ends of the connecting means 6, and to the support 3 and/or the float means 1.

Preferably, the support 3 can include at least one compartment (not shown) provided with at least one opening enabling filling with seawater when the support 3 is submerged, said compartment, which may be associated with a pump, thus constituting a ballast.

The water vehicle according to the invention also includes propulsion means preferably made up of a pedal and gear 9—transmission means—propeller 11 assembly and/or a motor—transmission means—propeller 11 assembly.

Thus, as shown in FIGS. 3 to 5, the water vehicle comprises, in this case:
a box 7 connected to the support 3 by rigid connecting means 8 that may consist of rods; this box 7 extends under the main body of the support 3 so that their longitudinal axes are substantially parallel; furthermore, this box 7 includes two pedal and gear mechanisms 9 as well as transmission means (not shown) preferably provided inside said box 7, which makes it possible to avoid exposing them to the sea environment directly, and to thus protect them against corrosion;
at least one propeller 11 preferably provided at the back, substantially in the longitudinal axis of the box 7, said propeller 11 in this case being connected by a rigid connecting means 12 to the main body of the support 3; this propeller 11 is connected to the plates of the pedal and gear mechanisms 9 by said transmission means, which may include:
   a transmission belt or chain (not shown) present in said box 7, which connects the plates of the two pedal and gear mechanisms 9;
   a secondary transmission belt or chain 13 connecting the plate of the back pedal and gear mechanism 9 to a transmission shaft (or to another belt or chain) that extends in the main body of the support 3, and/or in the rigid connecting means 12; the end of said transmission shaft is connected to said propeller 11.

The pedal and gear mechanisms 9 are of course provided so as to allow users seated on said seats 4 to be able to pedal.

Preferably, the seat 4—pedal and gear mechanism 9 assembly can be inclined so as to allow said pedal and gear mechanism 9 to be more easily provided above the surface when the support 3 is above water, the height of the pedal and gear mechanism 9 preferably being adjustable.

According to one alternative embodiment of the invention (not shown), irrespective of whether it includes pedal and gear mechanisms, the water vehicle may include two propellers of the aforementioned type, oriented in opposite directions, one being positioned in front and the other in back.

Preferably, each propeller 11 is pivotable, and provided under the main body of the support 3 so as to remain under water even when the support 3 is in the raised position. According to one alternative embodiment of the invention, the height positioning of each propeller 11 can be controlled so that the propeller 11 remains in the water when the support 3 is on the surface, and is in the axis of the support 3 when the latter is submerged.

According to one alternative embodiment the invention, as shown in FIG. 1, the support 3 comprises two protuberances 10, with vertical axes, connected to the lower surface of the support 3, and each extending so as to be substantially coaxial with the vertical axis of a respective seat 4. Each of these protuberances 10 comprises a pedal and gear mechanism 9 provided so as to allow users to be able to pedal.

The support 3 of the water vehicle according to the invention can comprise a gearbox (not shown) allowing users to select the speeds, and to thereby adapt the forces to be provided as a function of the condition of the sea.

According to one alternative embodiment of the invention, the propulsion means can be made up of the motor (not shown) driving, owing to the transmission means, at least one propeller, the motor possibly being a heat or electric engine. These propulsion means may also consist of a water jet propulsion system such as a hydrojet.

Preferably, the water vehicle according to the invention can comprise at least one electric motor in each float 1, each of which can be associated with a set of rechargeable batteries, preferably by means of a unit comprising a 12 V generator.

Advantageously, the propulsion means can comprise both at least one pedal and gear mechanism 9 and a motor that makes it possible to ease or reduce the force necessary to move the water vehicle.

The water vehicle according to the invention may also comprise photovoltaic panels (not shown) preferably provided on the float means 1, which in particular make it possible to power the electric motor.

According to another alternative embodiment of the invention, the water vehicle according to the invention may comprise at least one compressor, preferably electric (not shown), potentially associated with a pump, making it possible to compress the air, which can be suctioned on the surface by peddling. In this way, a controlled discharge of a flow of air makes it possible to propel the water vehicle.

Advantageously, this compressor can serve as an air tank allowing users, by means of pressure reducers 14 or elongated snorkels, to breathe while submerged.

The water vehicle according to the invention can also include a compressor of the aforementioned type making it possible to inflate said floats when the latter are flexible.

Furthermore, the water vehicle according to the invention include steering means that may consist of at least one handlebar 15, provided on the upper surface of the support 3, connected by transmission means (not shown) to at least one rudder extending under the support 3, and placed in front of or behind the water vehicle.

According to one alternative embodiment of the invention, said propellers 11 may be steerable and include a protuberance 16 comparable to a rudder blade.

Advantageously, the support 3 can also comprise, on the upper surface thereof, at least one support means constituting a wrist rest 17, serving as support for the hands of the passenger situated at the back.

In order to guarantee good visibility while submerged, the water vehicle may include a periscope (not shown) and/or a diving compass (not shown). Nevertheless, in most cases, users may see what is happening on the surface by standing up.

Advantageously, the support 3 may include at least one compartment (not shown) in which a ballast, for example consisting of sounding leads, may be provided, said compartment being provided and formed so as to guarantee the balance of the assembly even when it is full.

Furthermore, in order to ensure balance of the users underwater, the latter may:
wear lead belts (not shown), as used by underwater divers, which preferably include a closing system allowing easy and quick buckling and unbuckling; or
wear belts (not shown) connecting them to the float means 1, but which may easily be detached so as to allow the users to free themselves easily if necessary; these belts may be elastic and comprise a closing system of the Velcro type (registered trademark), which comprises two bands respectively provided at one of the ends of the belt, and which fasten to one another using fibers comprising loops or hooks at their free ends. In this way, the loops of the fibers of one of the band cooperate with the hooks of the fibers of the other band, which makes it possible to buckle and unbuckle said belt easily and quickly.

Furthermore, the water vehicle according to the invention can also comprise breathing means that may include at least one pressure reducer 14 or an elongated snorkel, connected by at least one flexible hose 22 to at least one opening 23 formed in the part of the structure of said water vehicle that remains on the surface, said opening 23 emerging in the open air.

The flexible hoses 22 preferably have a length substantially equal to 15 m, which advantageously makes it possible to move in a relatively large area around the submerged support 3.

Advantageously, due to the low pressures to which it will be subjected, the structure of the pressure reducer 14 may be simplified, and may be configured to make it possible to expel the exhaled gases into the water and not into the breathing system.

As shown in FIGS. 4 and 5, the breathing means can include two hoses 22 with a length substantially equal to 60 cm.

The openings 23 can be formed in the float means 1 and configured so as to be able to provide a tip therein comprising, at the apex thereof, a means making it possible to prevent water from becoming inserted therein, such as a valve or a protuberance in the form of a dome or funnel.

Said tip, which is similar to a vent, is preferably made from a slightly flexible plastic material.

According to one preferred embodiment of the invention, as shown in FIGS. 4 and 5, the support 3 can include at least two protuberances in the form of an air shaft 24 each comprising an opening 23 of the aforementioned type, which emerges at the rear surface of the protuberance 24, and in which a tip 25 of the aforementioned type is provided. In this way, and advantageously, water intrusions are limited as much as possible.

Advantageously, the tips 25 can be secured by screwing and unscrewing, which makes it possible to empty them and clean them easily.

According to one alternative embodiment of the invention, as shown in FIG. 5, the water vehicle may comprise at least one of the following elements:
a signal flag and a pole support 18; and/or
a storage chest 19 preferably provided in the back; and/or
at least one oar 20.

The water vehicle according to one alternative embodiment of the invention may also include at least one of the following elements:
storage nets (not shown) provided on or between the float means 1;
at least one protective device (not shown) protecting against sun and rain, such as a canvas wind shield;
at least one lighting means (not shown) that may be powered by a direct-current generator;
at least one sail (not shown) enabling the water vehicle according to the invention to use the wind to move;
at least one pedal and gear mechanism (not shown) mounted on the handlebar 15, allowing peddling with the hands, this “manual” pedal and gear mechanism operating in synchronization with the actuated-actuated pedal and gear mechanism 9;
at least one pedal and gear mechanism and one seat (not shown) provided on the support 3, so as to allow users to pedal in the lying down position;
at least one anchor means (not shown) such as an anchor;
at least one fuel tank (not shown) in the event the water vehicle according to the invention includes a heat engine;
at least one steering compass (not shown);
at least one windshield or faring element secured on the support 3 so as to protect passengers from spraying;
at least one gripping arm fastened to the support 3 that may include, at the free end thereof, a rotary brush or a fastening system such as a suction pad making it possible to moor the water vehicle to a ship or any other object;
at least one bottle of compressed air (not shown), which makes it possible to:
   propel the water vehicle when the support 3 is submerged;
   inflate the float means 1 more quickly and more easily;
   bleed the ballast(s) more quickly and more easily, the latter thus being able to include a tip making it possible to connect an air bottle of the aforementioned type; in the case where the support 3 includes at least one compartment constituting a ballast, bleeding the latter part using an air bottle makes it possible to cause said support 3 to rise;
   have a backup air supply;
   allow users to dive traditionally, independently, with a bottle on their backs.

According to one alternative embodiment of the invention, as shown in FIGS. 6 and 7, the support 3 may consist of a cradle provided with no pedal and gear mechanism, the assembly then preferably being propelled using an electric heat engine cooperating with a transmission means - propeller assembly of the aforementioned type, or a water jet propulsion system such as a hydrojet.

Each float 1 may include at least one portion constituting a ballast. Preferably, each float 1 includes a central portion constituting a ballast as well as a front portion and a back portion provided on either side of the central portion.

The water vehicle according to this alternative embodiment of the invention may also comprise a rail (not shown) made up of a raised ramp relative to the floats 1, and fastened to itself. This rail, which is provided above the cradle 3, is connected to the front and rear portions of the floats 1 by four arms (not shown) each extending from one of the corners of the rail that preferably delimits a rectangular surface.

The support 3 according to this alternative embodiment of the invention is provided with no pedal and gear mechanisms and is substantially in the shape of a cradle that may comprise:
a body making up a ballast;
potentially a rail (not shown);
a control desk 101 in particular making it possible to steer the water vehicle, but also to control the raising and lowering of the cradle.

In order to ensure the raising and lowering of the cradle 3, the water vehicle according to this alternative embodiment of the invention may include means such as:
cables associated with at least one winch (not shown); or
said connecting means 6; or
hydraulic jacks (not shown); or
scissor-shaped arms (not shown);

said means being connected, at one end thereof, to any part of the water vehicle remaining above water.

Advantageously, in order to optimize the stability of the cradle 3 underwater, the water vehicle according to this alternative embodiment of the invention may comprise folding or telescoping arms 100, which are fully deployed when the cradle is completely above water, said arms being connected on the one hand to the floats 1 and/or to any portion of the water vehicle that remains above water, and on the other hand to the cradle 3.

The water vehicle according to this alternative embodiment of the invention may also include two surface bridges (not shown), stationary, preferably made up of grids, provided between the floats 1, in front of and behind the above-water cradle 3, said bridges for example making it possible to move around, store equipment, etc.

The water vehicle according to this alternative embodiment of the invention may also comprise breathing means that may include at least one pressure reducer or an elongated snorkel connected by at least one flexible hose to at least one opening formed in the portion of the structure of said water vehicle that remains on the surface, said opening emerging in the open air.

1. A water vehicle moving on or in a liquid, which comprises float means (1) connected by connecting means (6) to a support (3),
characterized in that said connecting means (6) are configured so as to allow said support (3) to assume at least two positions, i.e.:
a raised position where the longitudinal axis of said support (3) and those of the float means (1) extend substantially in the same horizontal plane, the support (3) then being on the surface and able to constitute a central hull;
a lowered position where said support (3) extends under the plane comprising the longitudinal axis of each of the float means (1), the support (3) then being submerged.

2. The water vehicle according to claim 1, characterized in that the float means (1) constitute two parallel floats (1) with longitudinal axes, which each form a lateral hull.

3. The water vehicle according to claim 1, characterized in that it includes two parallel floats (1) and a support (3) with a longitudinal axis that extends between said float means (1), the longitudinal axis of the support (3) being parallel to that of the float means (1).

4. The water vehicle according to claim 2, characterized in that said two floats (1) are connected to one another by connecting means (2) consisting of at least one cross tie (2) connected at each of its ends to the upper portion of the corresponding float (1), each cross tie (2) being able to be substantially hoop-shaped.

5. The water vehicle according to claim 1, characterized in that the support (3) comprises, on the upper surface thereof, at least one location (4) making it possible to place at least one passenger, comprising a seat (4) that may consist of a seat (4).

6. The water vehicle according to claim 5, characterized in that the front part of each cross tie (2) comprises a central indentation (5) whereof the longitudinal axis fits substantially into the longitudinal plane of symmetry of the water vehicle; this indentation (5) matches the shape of the back portion of the corresponding seat (4), so as to allow better fastening of the support (3) to the float means (1) when said support (3) is in the raised position.

7. The water vehicle according to claim 1, characterized in that said connecting means (6) include rigid elements whereof the respective ends are connected to the float means (1) and the support (3), said connecting means (6) then being able to cooperate with gear mechanisms when they are rigid, or to wind around pulleys when they are flexible.

8. The water vehicle according to claim 1, characterized in that it includes control means allowing the passengers to control the raising or lowering of said support.

9. The water vehicle according to claim 8,characterized in that said control means consist of a rudder or winch, whether manual or electric.

10. The water vehicle according to claim 8, characterized in that said control means consist of a pedal and gear mechanism (9)—gearbox assembly; the pedal and gear mechanism (9) is used for winding or unwinding the connecting means (6), the gearbox more specifically making it possible to control said winding or unwinding.

11. The water vehicle according to claim 1, characterized in that it also comprises fastening means that make it possible to fasten the support (3) to the float means (1) and/or to the cross ties (2) when said support (3) is in the raised position.

12. The water vehicle according to claim 1, characterized in that it comprises disconnectable fastening means connected to the ends of the connecting means (6), and to the support (3) and/or the float means (1) which allows the support (3) to separate from the float means (1).

13. The water vehicle according to claim 12, characterized in that the support of the water vehicle can include a closed receptacle comprising at least one porthole.

14. The water vehicle according to claim 1, characterized in that the support (3) includes at least one compartment provided with at least one opening enabling filling with seawater when the support (3) is submerged, said compartment thus constituting a ballast.

15. The water vehicle according to claim 1, characterized in that it comprises propulsion means made up of a pedal and gear mechanism (9)—transmission means—propeller (11) assembly and/or a motor—transmission means—propeller (11) assembly.

16. The water vehicle according to claim 15, characterized in that it comprises:
a box (7) connected to the support (3) by rigid connecting means (8); this box (7) extends under the main body of the support (3) so that their longitudinal axes are substantially parallel; furthermore, this box (7) includes two pedal and gear mechanisms (9) as well as transmission means;
at least one propeller (11) preferably provided at the back, substantially in the longitudinal axis of the box (7), said propeller (11) in this case being connected by a rigid connecting means (12) to the main body of the support (3); this propeller (11) is connected to the plates of the pedal and gear mechanisms (9) by said transmission means, which may include a transmission belt or chain connecting the plates of the two pedal and gear mechanisms (9), as well as a secondary transmission belt or chain (13) connecting the plate of the back pedal and gear mechanism (9) to a transmission shaft or to another belt or chain whereof the end is connected to said propeller (11).

17. The water vehicle according to claim 15, characterized in that the support (3) comprises a gearbox allowing users to select the speeds, and to thereby adapt the forces to be provided as a function of the condition of the sea.

18. The water vehicle according to claim 1, characterized in that it comprises a compressor making it possible to compress the air, which can be suctioned on the surface by peddling.

19. The water vehicle according to claim 1, characterized in that it includes steering means that may consist of at least one handlebar (15), provided on the upper surface of the support (3), connected by transmission means to at least one rudder extending under the support (3), and placed in front of or behind the water vehicle.

20. The water vehicle according to claim 15, characterized in that the propellers (11) are steerable and include a protuberance (16) comparable to a rudder blade.

21. The water vehicle according to claim 1, characterized in that the support (3) includes at least one compartment in which a ballast may be provided, said compartment being provided and formed so as to guarantee the balance of the assembly even when it is full.

22. The water vehicle according to claim 1, characterized in that it comprises breathing means including at least one pressure reducer (14) or an elongated snorkel connected by at least one flexible hose (22) to at least one opening (23) formed in the part of the structure of said water vehicle that remains on the surface, said opening (23) emerging in the open air.

23. The water vehicle according to claim 22, characterized in that the openings (23) are formed in the float means (1) and are configured so as to be able to provide a tip therein comprising, at the apex thereof, a means making it possible to prevent water from becoming inserted therein, such as a valve or a protuberance in the form of a dome or funnel.

24. The water vehicle according to claim 22, characterized in that the support (3) comprises at least two protuberances in the form of an air shaft (24) each comprising an opening (23) of the aforementioned type, which emerges at the rear surface of the protuberance (24), and in which a tip (25) of the aforementioned type is provided.

25. The water vehicle according to claim 2, characterized in that it includes at least one electric engine in each float (1).

26. The water vehicle according to claim 1, characterized in that the support (3) consists of a cradle provided with no pedal and gear mechanism, the assembly then preferably being propelled using an electric heat engine cooperating with a transmission means—propeller assembly of the aforementioned type, or a water jet propulsion system such as a hydrojet.

27. The water vehicle according to claim 26, characterized in that each float (1) includes at least one portion constituting a ballast made up of the central portion of the float (1), as well as a front portion and a back portion provided on either side of the central portion.

28. The water vehicle according to claim 27, characterized in that it also comprises a rail made up of a raised ramp relative to the floats (1), and fastened to itself; this rail, which is provided above the cradle (3), is connected to the front and rear portions of the floats (1) by four arms each extending from one of the corners of the rail.

29. The water vehicle according to claim 26, characterized in that the support (3) it comprises:
a body constituting a ballast;
a rail;
a control desk (101) making it possible to steer the water vehicle, but also to control the raising and lowering of the cradle (3).

30. The water vehicle according to claim 26, characterized in that it comprises means such as:
cables associated with at least one winch; or
said connecting means (6); or
hydraulic jacks; or
scissor-shaped arms;
said means being connected, at one end thereof, to any part of the water vehicle remaining above water.

31. The water vehicle according to claim 26, characterized in that it comprises folding or telescoping arms (100), which are fully deployed when the cradle is completely above water, said arms being connected on the one hand to the floats (1) and/or to any portion of the water vehicle that remains above water, and on the other hand to the cradle (3).

32. The water vehicle according to claim 26, characterized in that it includes two surface bridges, stationary, provided between the floats (1), in front of and behind the above-water cradle (3).
